(19) United States
(12) Patent Application Publication
(10) Pub. No.: US 2025/0323378 A1
(43) Pub. Date: Oct. 16, 2025

(54) ENERGY STORAGE DEVICE

(71) Applicant: TOYOTA JIDOSHA KABUSHIKI KAISHA, Toyota-shi (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 19/074,110

(22) Filed: Mar. 7, 2025

(30) Foreign Application Priority Data
Apr. 11, 2024 (JP) 2024-063762

(51) Int. Cl. H01M 50/358; B60L 50/60; B60L 50/64; H01M 50/209; H01M 50/249

(52) U.S. Cl. CPC H01M 50/358; B60L 50/66; H01M 50/209; H01M 50/249; B60L 50/64; H01M 2220/20

(57) ABSTRACT

An energy storage device includes a first energy storage stack and a second energy storage stack, an electrical device, and a housing case, and the housing case is provided with a case-side discharge valve capable of discharging the gas discharged into the housing case, the first energy storage stack and the second energy storage stack are arranged side by side at intervals in the first direction, the electrical device is arranged in a clearance between the first energy storage stack and the second energy storage stack, and a space capable of flowing the gas discharged from the first energy storage stack or the gas discharged from the second energy storage stack is provided in a clearance between the first energy storage stack and the second energy storage stack.

### CROSS-REFERENCE TO RELATED APPLICATION

This application claims priority to Japanese Patent Application No. 2024-063762 filed on Apr. 11, 2024, incorporated herein by reference in its entirety.

### BACKGROUND

### 1. Technical Field

The present disclosure relates to energy storage devices mounted on vehicles.

### 2. Description of Related Art

Japanese Unexamined Patent Application Publication (Translation of PCT Application) No. 2022-516519 (JP 2022-516519 A) discloses, as a conventional energy storage device, a structure in which part of a housing case that houses a plurality of energy storage stacks is composed of a hollow member, and a hollow portion of the hollow member is used as a channel through which a gas discharged from the energy storage stacks flows. A bottom wall or side wall of the housing case has a plurality of inlet holes for introducing the gas into the channel.

### SUMMARY

However, in the case where the bottom wall or side wall of the housing case has a large number of inlet holes as disclosed in JP 2022-516519 A, the rigidity of the housing case may decrease.

The present disclosure was made in view of the above issue, and an object of the present disclosure is to provide an energy storage device configured to discharge a gas discharged from an energy storage stack to the outside of a housing case while reducing a decrease in rigidity of the housing case.

An energy storage device according to the present disclosure includes:
a first energy storage stack and a second energy storage stack;
an electrical device configured to control the first energy storage stack and the second energy storage stack; and
a housing case that houses the first energy storage stack, the second energy storage stack, and the electrical device.
   The housing case is provided with a case-side discharge valve configured to discharge a gas discharged into the housing case. The first energy storage stack and the second energy storage stack are arranged next to each other at an interval in a first direction. The electrical device is disposed in a clearance between the first energy storage stack and the second energy storage stack. A space configured to allow the gas discharged from the first energy storage stack or the gas discharged from the second energy storage stack to flow in the space is provided in the clearance between the first energy storage stack and the second energy storage stack.

With the above configuration, the gas discharged from the first energy storage stack and/or the second energy storage stack can be discharged to the outside from the case-side discharge valve via the clearance between the first energy storage stack and the second energy storage stack in which the electrical device is disposed. Since it is not necessary to form a large number of holes for introducing the gas from each energy storage stack into a discharge path in the housing case, the rigidity of the housing case can be satisfactorily maintained.

In the energy storage device according to the present disclosure, the housing case may include a bottom wall and a peripheral wall connected to the bottom wall. The case-side discharge valve may be located in a portion of the peripheral wall that faces the clearance between the first energy storage stack and the second energy storage stack.

The above configuration can minimize the time it takes to discharge the gas discharged into the space provided in the clearance between the first energy storage stack and the second energy storage stack to the outside of the housing case. Accordingly, the first energy storage stack and the second energy storage stack are less likely to be heated by the gas.

In the energy storage device according to the present disclosure,
the first energy storage stack may include a plurality of first unit cells arranged in a second direction perpendicular to the first direction.
   The second energy storage stack may include a plurality of second unit cells arranged in the second direction.
   Each of the first unit cells may be provided with a first discharge valve configured to discharge the gas toward the second energy storage stack. Each of the second unit cells may be provided with a second discharge valve configured to discharge the gas toward the first energy storage stack.

With the above configuration, the gas from the first energy storage stack and the second energy storage stack can be directly discharged to the space.

In the energy storage device according to the present disclosure, the electrical device may be disposed at such a position that the electrical device does not overlap a plurality of the first discharge valves and a plurality of the second discharge valves in the first direction.

With the above configuration, the gas from the first energy storage stack and the second energy storage stack is less likely to directly blow onto the electrical device.

In the energy storage device according to the present disclosure, the electrical device may include a cell electronic control unit (ECU) and a junction box; The cell ECU may be disposed in a middle portion in a second direction perpendicular to the first direction in the clearance. The junction box may be disposed next to the cell ECU in the second direction.

With the above configuration, the gas more tends to accumulate at both ends in the second direction of the clearance between the first energy storage stack and the second energy storage stack. Since the cell ECU is disposed in the middle portion in the second direction, the cell ECU is less likely to be heated by the stagnant gas.

The energy storage device according to the present disclosure may further include a rectifying plate disposed in the clearance. The rectifying plate may be configured to guide the gas from the first energy storage stack or the gas from the second energy storage stack toward both outer sides of the electrical device in the second direction.

With the above configuration, since the rectifying plate is present, the gas from the first energy storage stack and the second energy storage stack is less likely to directly blow onto the electrical device.

The present disclosure can provide an energy storage device configured to discharge a gas discharged from an energy storage stack to the outside of a housing case while reducing a decrease in rigidity of the housing case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a vehicle according to a first embodiment;

FIG. 2 is a diagram illustrating a state in which the energy storage device according to the first embodiment is fixed to a vehicle body;

FIG. 3 is a schematic exploded perspective view of an energy storage device according to the first embodiment;

FIG. 4 is a schematic plan view illustrating an internal configuration of the energy storage device according to the first embodiment;

FIG. 5 is a schematic cross-sectional view taken along line V-V shown in FIG. 4; and

FIG. 6 is a schematic plan view illustrating an internal configuration of the energy storage device according to the second embodiment.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

### First Embodiment

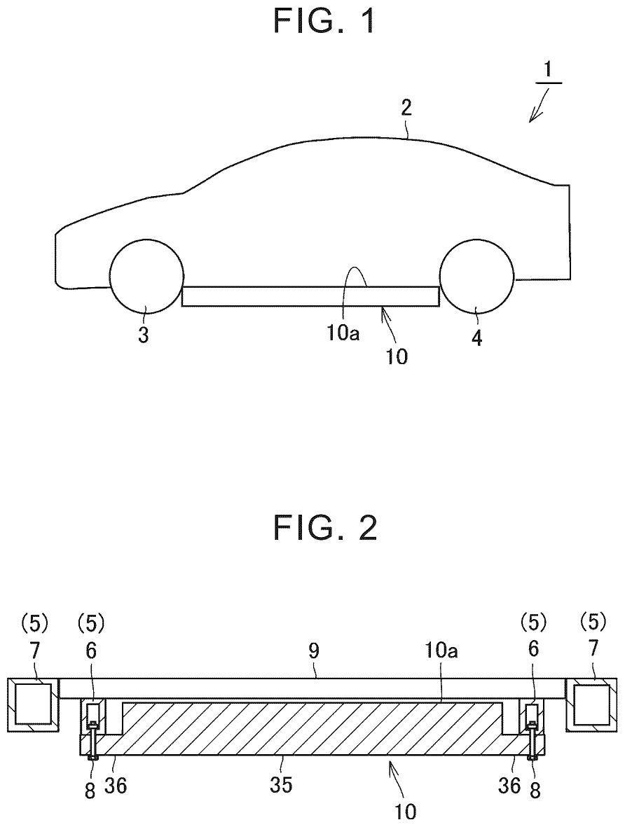

FIG. 1 is a schematic diagram illustrating a vehicle according to a first embodiment. FIG. 2 is a diagram illustrating a state in which the energy storage device according to the first embodiment is fixed to a vehicle body. Referring to FIGS. 1 and 2, a vehicle 1 according to a first embodiment will be described.

The vehicle 1 is a hybrid electric vehicle that can travel by using power of either or both of a motor and an engine, or an electrified vehicle that travels by a driving force obtained by electric energy.

The vehicle 1 includes a vehicle body 2, a front wheel 3, a rear wheel 4, and an energy storage device 10. The vehicle body 2 includes a frame member 5. The energy storage device 10 is disposed below the vehicle body 2. The energy storage device 10 is disposed, for example, between the front wheel 3 and the rear wheel 4. Note that a part of the energy storage device 10 may be disposed so as to overlap either or both of the front wheel 3 and the rear wheel 4 when viewed from the width direction of the vehicle 1. The energy storage device 10 has an upper surface 10a. The upper surface 10a may function as a floor member defining the interior of the vehicle.

The frame member 5 includes a pair of side members 6 and a pair of side sills 7. The pair of side sills 7 is disposed on both end sides in the width direction of the vehicle 1. The pair of side members 6 are disposed inside the pair of side sills 7 at a distance. The pair of side members 6 and the pair of side sills 7 extend along the front-rear direction of the vehicle 1.

The pair of side members 6 are spaced apart in the width direction of the vehicle 1. A main body portion 35 of the energy storage device 10 is disposed in a clearance between the pair of side members 6. A clearance is provided between the main body portion 35 and the pair of side members 6. Thus, even when the vehicle 1 collides laterally, it is possible to prevent an impact from being input to the energy storage device 10.

The fixed portions 36 are provided on both side surfaces of the main body portion 35 in the width direction of the vehicle 1. The fixed portions 36 are fixed to the pair of side members 6 by the fastening member 8.

The frame member 5 also includes a cross-frame member 9. The cross-frame member 9 is provided so as to straddle from one side sill 7 to the other side sill 7 above the energy storage device 10. An upper surface 10a of the energy storage device 10 is fixed to the cross-frame member 9.

In the above description, a case in which the frame member 5 includes the pair of side members 6 and the pair of side sills 7 has been described as an example, but the present disclosure is not limited thereto. The pair of side sills 7 may also have the function of the pair of side members 6. In this case, the pair of side members 6 may be omitted, and the fixed portions 36 may be fixed to the pair of side sills 7.

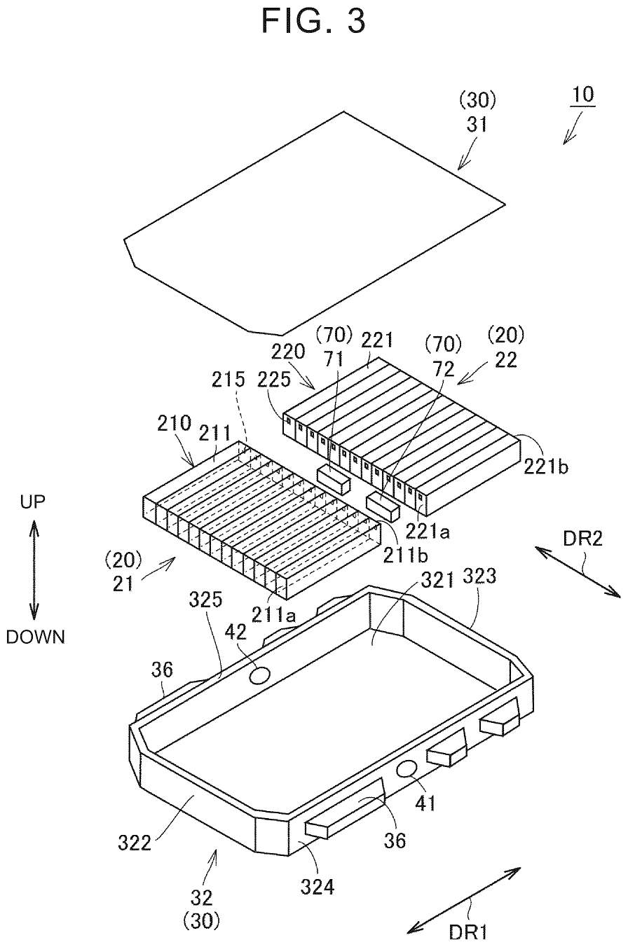

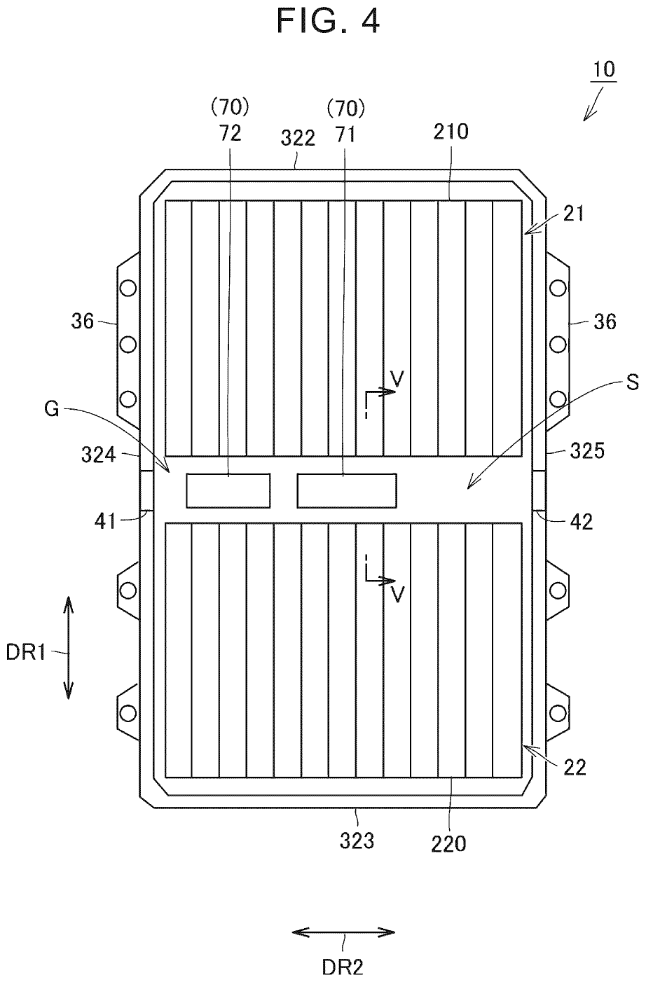

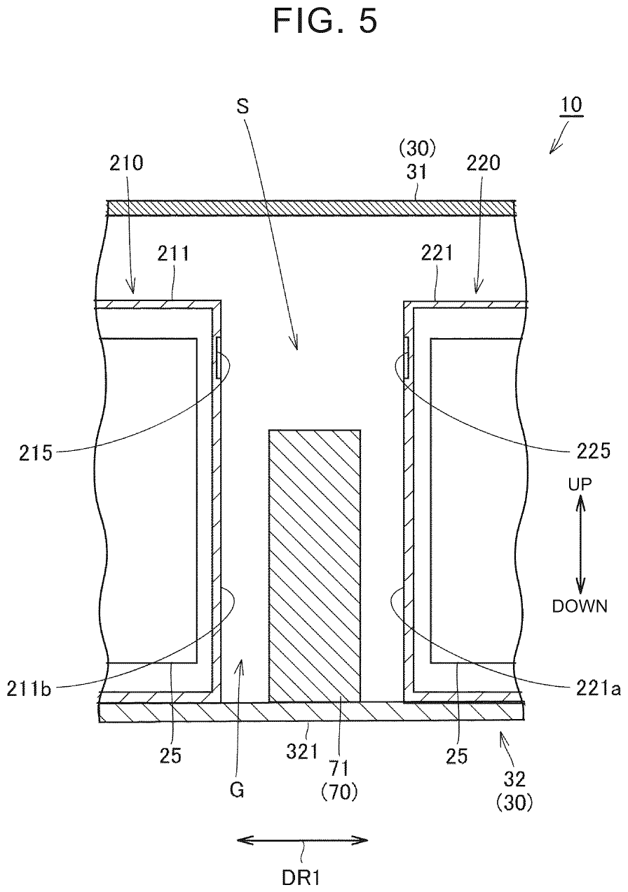

FIG. 3 is a schematic exploded perspective view of an energy storage device according to the first embodiment. FIG. 4 is a schematic plan view illustrating an internal configuration of the energy storage device according to the first embodiment. FIG. 5 is a schematic cross-sectional view taken along IV-IV shown in FIG. 4. The details of the energy storage device 10 will be described with reference to FIGS. 3 to 5.

As illustrated in FIGS. 3 and 4, the energy storage device 10 includes an energy storage module 20, a housing case 30, case-side discharge valves 41, 42, and an electrical device 70.

The energy storage module 20 includes a first energy storage stack 21 and a second energy storage stack 22. The first energy storage stack 21 and the second energy storage stack 22 are arranged side by side at intervals in the first direction. The first direction is, for example, parallel to the front-rear direction of the vehicle 1 in a mounted state in which the energy storage device 10 is mounted on the vehicle 1. A clearance G is formed between the first energy storage stack 21 and the second energy storage stack 22.

The first energy storage stack 21 is located on one side in the first direction, and the second energy storage stack 22 is located on the other side in the first direction. The first energy storage stack 21 and the second energy storage stack 22 are electrically connected in series.

The first energy storage stack 21 includes a plurality of first unit cells 210. The plurality of first unit cells 210 is electrically connected in series. The plurality of first unit cells 210 is arranged in a second direction (DR2 direction) perpendicular to the first direction. The second direction is, for example, parallel to the left-right direction of the vehicle 1 in the above-described mounted state.

The first unit cell 210 has a longitudinal shape that is a first direction and a longitudinal direction. The first unit cell 210 has a flat rectangular parallelepiped shape having a thickness in the second direction.

The first unit cell 210 includes a housing 211. The housing 211 has a first end face 211a and a second end face 211b arranged in the first direction. The first end face 211a faces away from the side where the second energy storage stack 22 is located in the first direction. The second end face 211b faces toward the second energy storage stack 22. A first discharge valve 215 is provided on the second end face 211b.

The plurality of first unit cells 210 is arranged such that the first discharge valves 215 face the second energy storage stack 22. The first discharge valve 215 opens when the internal pressure of the housing 211 exceeds a predetermined value, and discharges the gas in the housing 211 to the outside of the housing 211. Specifically, the first discharge valve 215 discharges the gas toward the second energy storage stack 22.

The second energy storage stack 22 includes a plurality of second unit cells 220. The plurality of second unit cells 220 is electrically connected in series. The plurality of second unit cells 220 is arranged in the second direction.

The second unit cell 220 has a longitudinal shape having a first direction and a longitudinal direction. The second unit cell 220 has a flat rectangular parallelepiped shape having a thickness in the second direction.

The second unit cell 220 includes a housing 221. The housing 221 has a first end face 221a and a second end face 221b arranged in the first direction. The first end face 221a faces toward the first energy storage stack 21. The second end face 221b faces away from the side where the first energy storage stack 21 is located in the first direction. A second discharge valve 225 is provided on the first end face 221a.

The plurality of second unit cells 220 is arranged such that the second discharge valves 225 face the first energy storage stack 21. The second discharge valve 225 opens when the internal pressure of the housing 221 exceeds a predetermined value, and discharges the gas in the housing 221 to the outside of the housing 221. Specifically, the second discharge valve 225 discharges the gas toward the first energy storage stack 21.

One or more electrode bodies 25 are accommodated in the housings 211, 221. When a single electrode body 25 is accommodated in the housings 211, 221, the electrode body 25 has a shape extending in the longitudinal direction. The electrode body 25 may be a laminated electrode body in which a negative electrode sheet, a separator, and a positive electrode sheet are laminated, or may be a wound electrode body in which a negative electrode sheet, a separator, and a positive electrode sheet are wound.

When the plurality of electrode bodies 25 are accommodated in the housings 211, 221, the plurality of electrode bodies 25 are arranged side by side in the longitudinal direction and are connected in series. Also in this case, the electrode body 25 may be a laminated electrode body or a wound electrode body.

The first unit cell 210 and the second unit cell 220 are secondary cells such as nickel metal hydride cells or lithium-ion cells. The first unit cell 210 and the second unit cell 220 may be formed using a liquid electrolyte or a solid electrolyte. The first unit cell 210 and the second unit cell 220 may be chargeable and dischargeable capacitors.

The housing case 30 includes an upper member 31 and a lower member 32 as a lower case. The lower member 32 has a substantially box-shaped shape that opens upward. The lower member 32 includes a main body portion 35 and the fixed portions 36.

The main body portion 35 includes a bottom wall 321, a first wall 322, a second wall 323, and a pair of side walls 324, 325. The first wall 322, the second wall 323, and the pair of side walls 324, 325 are provided so as to stand up from the peripheral edge of the bottom wall 321. The first wall 322, the second wall 323, and the pair of side walls 324, 325 constitute a peripheral wall. The peripheral wall is connected to a peripheral edge portion of the bottom wall 321.

The first wall 322 and the second wall 323 face each other in the first direction. The first wall 322 is located on one side in the first direction. The second wall 323 is located on the other side in the first direction. The pair of side walls 324, 325 oppose each other in the second direction. The pair of side walls 324, 325 connect the first wall 322 and the second wall 323. The side wall 324 connects end portions of the first wall 322 and the second wall 323 located on one side in the second direction. The side wall 325 connects end portions of the first wall 322 and the second wall 323 located on the other side in the second direction.

The fixed portions 36 are provided on the outer surfaces of the pair of side walls 324, 325. The fixed portions 36 are provided so as to extend intermittently in the first direction. A portion of the fixed portion 36 located furthest on the one side in the first direction is longer in length in the first direction than the other portions.

The upper member 31 has a substantially plate-like shape. The upper member 31 closes the opening of the lower case 200. The shape of the upper member is not limited to a plate shape, and may be a substantially box shape that opens downward.

The electrical device 70 is disposed in a clearance between the first energy storage stack 21 and the second energy storage stack 22. The electrical device 70 includes, for example, a cell ECU (Electronic Control Unit) 71 and a junction box 72. The cell ECU 71 is disposed at a middle portion in the second direction in the clearance. The junction box 72 is arranged side by side with the cell ECU 71 in the second direction. The junction box 72 is disposed on one side in the second direction with respect to the cell ECU 71.

As illustrated in FIG. 5, the electrical device 70 is disposed at a position not overlapping the plurality of first discharge valves 215 and the plurality of second discharge valves 225 in the first direction. Accordingly, it is possible to prevent the gas discharged from the first energy storage stack 21 and/or the second energy storage stack 22 from directly hitting the electrical device 70. The plurality of first discharge valves 215 and the plurality of second discharge valves 225 are positioned above the electrical device 70, for example.

Referring again to FIGS. 3 and 4, the peripheral wall of the housing case 30 is provided with case-side discharge valves 41, 42 capable of exhausting the gas discharged from the first energy storage stack 21 and/or the second energy storage stack 22 into the housing case 30. The case-side discharge valve 41 is provided in the side wall 324. The case-side discharge valve 42 is provided in the side wall 325.

The case-side discharge valves 41, 42 function as pressure release valves, and discharge the gas in the housing case 30 to the outside of the housing case 30 when the pressure in the housing case 30 becomes higher than a predetermined pressure.

A space S is provided in a clearance G between the first energy storage stack 21 and the second energy storage stack 22. The space S can flow the gas discharged from at least one of the plurality of first unit cells 210 included in the first energy storage stack 21 or the gas discharged from at least one of the plurality of second unit cells 220 included in the second energy storage stack 22. The gas disposed in the space S is discharged from the case-side discharge valves 41, 42 to the outside of the housing case 30.

As described above, in the present embodiment, the gas can be discharged to the outside from the case-side discharge valves 41, 42 through the clearance G between the first energy storage stack 21 and the second energy storage stack 22 in which the electrical device 70 is disposed. Therefore, the energy storage device 10 according to the present embodiment can maintain the rigidity of the housing case 30 better than that of the comparative example. In the comparative example, a discharge path for discharging gas is provided inside the housing case, and a plurality of holes for introducing gas from a plurality of energy storage cells included in each energy storage stack into the discharge path are provided in the housing case. In addition, the energy storage device 10 according to the present embodiment does not require a process of providing a large number of holes in the housing case, and thus the manufacturing cost can be reduced.

Further, the case-side discharge valves 41, 42 are provided in a portion of the peripheral wall facing the clearance between the first energy storage stack 21 and the second energy storage stack 22. That is, the case-side discharge valves 41, 42 are provided substantially in the middle portions in the first direction of the pair of side walls 324, 325. Accordingly, the gas discharged to the space S provided in the clearance G between the first energy storage stack 21 and the second energy storage stack 22 can be discharged to the outside of the housing case 30 at the shortest time. As a result, the first energy storage stack 21 and the second energy storage stack 22 can be suppressed from being heated by the discharged gas.

Each of the plurality of first unit cells 210 is provided with a first discharge valve 215 capable of discharging gas toward the second energy storage stack 22. Each of the plurality of second unit cells 220 is provided with a second discharge valve 225 capable of discharging gas toward the first energy storage stack 21. Therefore, the gas from the first energy storage stack 21 and/or the second energy storage stack 22 can be directly discharged to the space S.

In the clearance G, gas tends to accumulate on both sides in the second direction. In the present embodiment, in the clearance G, the cell ECU 71 is disposed in the middle portion in the second direction, so that it is possible to prevent the cell ECU 71 from being heated by the stagnant gases.

### Second Embodiment

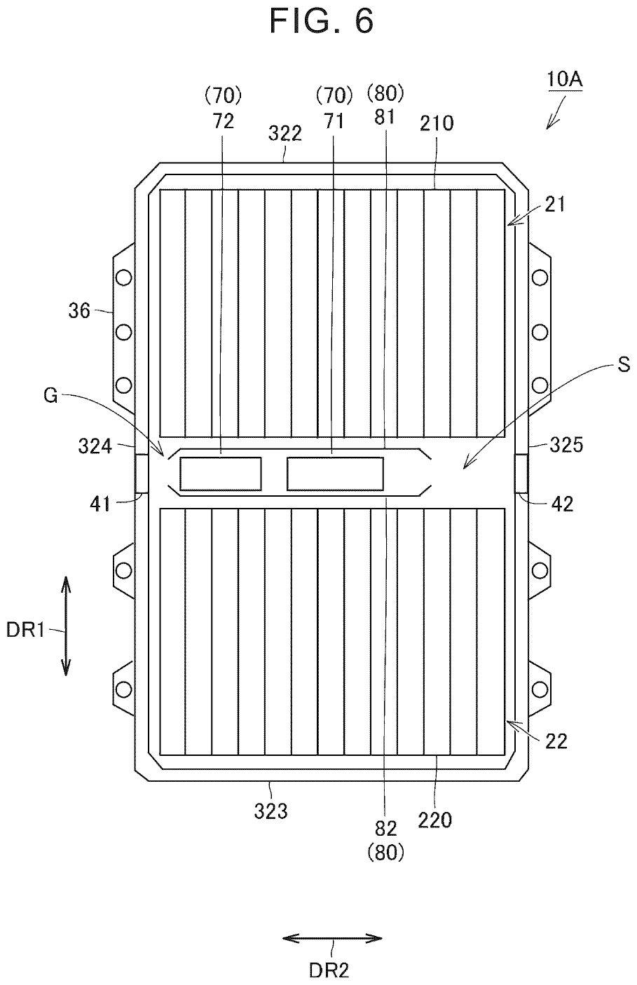

FIG. 6 is a schematic plan view illustrating an internal configuration of the energy storage device according to the second embodiment. Referring to FIG. 6, an energy storage device 10A according to a second embodiment will be described.

As shown in FIG. 6, the energy storage device 10A according to the second embodiment is different from the energy storage device 10 according to the first embodiment in that a rectifying plate 80 is provided. The other configurations are substantially the same.

The rectifying plate 80 guides the gas from the first energy storage stack 21 or the gas from the second energy storage stack 22 toward both outer sides of the electrical device 70 in the second direction in the clearance G between the first energy storage stack 21 and the second energy storage stack 22. That is, the rectifying plate 80 guides the gas toward portions of the space S located on both outer sides of the electrical device 70 in the second direction.

The rectifying plate 80 includes a first rectifying plate 81 and a second rectifying plate 82. The first rectifying plate 81 is disposed between the first energy storage stack 21 and the electrical device 70. The second rectifying plate 82 is disposed between the second energy storage stack 22 and the electrical device 70. In the second direction, the widths of the first rectifying plate 81 and the second rectifying plate 82 are larger than the widths of the electrical device 70. That is, the first rectifying plate 81 is disposed so as to cover the electrical device 70 from one side in the first direction. The second rectifying plate 82 is disposed so as to cover the electrical device 70 from the other side in the first direction.

Both end portions of the first rectifying plate 81 in the second direction are inclined toward the second rectifying plate 82. Both ends of the second rectifying plate 82 in the second direction are inclined toward the first rectifying plate 81.

Even with the configuration as described above, the energy storage device 10A according to the second embodiment has substantially the same advantages as the energy storage device 10 according to the first embodiment. In addition, since the rectifying plate 80 is disposed, it is possible to prevent the gas from the first energy storage stack 21 or the gas from the second energy storage stack 22 from directly blowing onto the electrical device 70.

In the first and second embodiments described above, the first direction is parallel to the front-rear direction of the vehicle 1 and the second direction is parallel to the left-right direction of the vehicle 1 in the mounted state, but the present disclosure is not limited thereto. The first direction may be parallel to the left-right direction of the vehicle 1, and the second direction may be parallel to the front-rear direction of the vehicle 1.

In Embodiments 1 and 2 described above, the case-side discharge valves 41, 42 are provided in portions facing the clearance G, but the present disclosure is not limited thereto. The clearance G is a clearance between the first energy storage stack 21 and the second energy storage stack 22 in the peripheral wall of the housing case 30. The case-side discharge valves 41, 42 may be provided in the first wall 322 or the second wall 323. In this case, an exhaust path for exhausting gas is provided inside the housing case 30 peripheral wall, and an introduction hole for introducing gas into the exhaust path is provided in a portion of the peripheral wall facing the clearance. In the above-described configuration, since the area in which the introduction hole is installed is limited, it is possible to prevent the rigidity of the housing case 30 from decreasing.

The embodiments disclosed herein are illustrative and not restrictive in all respects. The scope of the present disclosure is defined by the claims, and includes all modifications within the meaning and range equivalent to the claims.

What is claimed is:

1. An energy storage device comprising:
a first energy storage stack and a second energy storage stack;
an electrical device configured to control the first energy storage stack and the second energy storage stack; and
a housing case that houses the first energy storage stack, the second energy storage stack, and the electrical device, wherein:
the housing case is provided with a case-side discharge valve configured to discharge a gas discharged into the housing case;
the first energy storage stack and the second energy storage stack are arranged next to each other at an interval in a first direction;
the electrical device is disposed in a clearance between the first energy storage stack and the second energy storage stack; and
a space configured to allow the gas discharged from the first energy storage stack or the gas discharged from the second energy storage stack to flow in the space is provided in the clearance between the first energy storage stack and the second energy storage stack.

2. The energy storage device according to claim 1, wherein:
the housing case includes a bottom wall and a peripheral wall connected to the bottom wall; and
the case-side discharge valve is located in a portion of the peripheral wall that faces the clearance between the first energy storage stack and the second energy storage stack.

3. The energy storage device according to claim 1, wherein:
the first energy storage stack includes a plurality of first unit cells arranged in a second direction perpendicular to the first direction;
the second energy storage stack includes a plurality of second unit cells arranged in the second direction;
each of the first unit cells is provided with a first discharge valve configured to discharge the gas toward the second energy storage stack; and
each of the second unit cells is provided with a second discharge valve configured to discharge the gas toward the first energy storage stack.

4. The energy storage device according to claim 3, wherein the electrical device is disposed at such a position that the electrical device does not overlap a plurality of the first discharge valves and a plurality of the second discharge valves in the first direction.

5. The energy storage device according to claim 1, wherein:
the electrical device includes a cell electronic control unit and a junction box;
the cell electronic control unit is disposed in a middle portion in a second direction perpendicular to the first direction in the clearance; and
the junction box is disposed next to the cell electronic control unit in the second direction.
